(19) United States
(12) Patent Application Publication
(10) Pub. No.: US 2011/0114872 A1
(43) Pub. Date: May 19, 2011

(54) Process For Polishing A Silicon Surface By Means Of A Cerium Oxide-Containing Dispersion

(75) Inventors: Michael Kroell, Linsengericht (DE); Michael Kraemer, Schoeneck (DE); Gerfried Zwicker, Itzehoe (DE); Michael Torkler, Itzehoe (DE)

(73) Assignee: EVONIK DEGUSSA GMBH, ESSEN (DE)

(21) Appl. No.: 12/811,388

(22) PCT Filed: Dec. 12, 2008
(86) PCT No.: PCT/EP2008/067422

§ 371 Date: Jul. 1, 2010

(30) Foreign Application Priority Data
Feb. 8, 2008 (DE) 102008008184.1

(51) Int. Cl. C09K 13/00

(52) U.S. Cl. 252/79.1

(57) ABSTRACT

Process for polishing silicon surfaces, in which a dispersion which comprises cerium oxide particles, at least one polymeric, anionic dispersing additive and at least one oxidizing agent and which has a pH of 7 to 10.5 is used, said cerium oxide particles having a positive charge and polymeric, anionic dispersing additive and oxidizing agent being soluble in the liquid phase of the dispersion.

The invention relates to a process for polishing silicon surfaces by means of a dispersion which comprises cerium oxide particles, a polymeric, anionic dispersing additive and an oxidizing agent.

For the production of silicon wafers for use in microelectronics, typically three polishing steps are carried out:

1. The “stock removal” step after sawing, grinding and etching of the silicon wafer, which, for modern 300 mm wafers, is carried out in the form of a double-sided polishing process (DSP). For the removal of the grinding damage in the single crystal and for the achievement of a good wafer geometry (plane-parallelism), approx. 20 μm (10 μm per side) are removed. The dispersions used are based generally on colloidal silica. To achieve a higher removal rate, a high pH, approx. 11.5-12, is employed. To prevent partial etching of the silicon, the pH is lowered with a stop dispersion after the polishing process has ended. This is followed by hydrophilization, i.e. saturation of the silicon surface with OH groups or oxygen atoms. Only hydrophilized surfaces can be cleaned sufficiently well.

2. The “final polish” step. It ensures a defined smooth frontside of the polished wafer (which has been polished on both sides) and ensures, among other things, the removal of scratches or handling traces after DSP and wafer edge grinding/polishing. About 500 nm-1 μm are removed. Generally similar dispersions to those in the first step are used.

3. The “haze-free” polishing step. A particularly gentle polishing step once again removes a few tens of nanometres of silicon in order to obtain the wafer frontside smooth to angstrom level, which is required for chip production. This smooth surface is required in order to produce the extremely thin gate oxides which are obtained by thermal oxidation in homogeneous thickness. Local peaks in the silicon would lead to locally increased field strengths at these points and hence to possible electrical breakdowns of the insulator. For the “haze-free” step, very pure colloidal silica dispersions with very soft abrasive particles at a pH of about 10 or lower with a solids content of about 0.5% are used. For good cleaning after the polishing and a clean wafer surface, the wafers have to leave the polisher in hydrophilized form, and so, in many cases, additional hydrophilizing baths have to be used.

It was an object of the present invention to provide a process for polishing silicon surfaces, especially silicon wafers, in which costly and inconvenient stop and hydrophilizing baths can be dispensed with.

The invention provides a process for polishing silicon surfaces, characterized in that a dispersion which comprises cerium oxide particles, at least one polymeric, anionic dispersing additive and at least one oxidizing agent and which has a pH of 7.5 to 10.5 is used,
said cerium oxide particles having a positive charge and
polymeric, anionic dispersing additive and oxidizing agent being soluble in the liquid phase of the dispersion.

The positive charge of the cerium oxide particles can be determined via the zeta potential. The zeta potential is a measure for the surface charge of the particles, which can be shifted by polymeric, anionic dispersing additives which accumulate at the surface. The zeta potential is understood to mean the potential at the shear plane within the electrochemical cerium oxide particle/electrolyte double layer in the dispersion. An important parameter in connection with the zeta potential is the isoelectric point (IEP) for a particle. The IEP indicates the pH at which the zeta potential is zero.

The zeta potential of the cerium oxide particles is determined in the pH range of 7.5-10.5 by means of the electrokinetic sound amplitude. To this end, a dispersion which comprises 1% by weight of cerium oxide with water as the liquid phase is prepared. The dispersion is effected with an ultrasound rod (400 W). The dispersion is stirred with a magnetic stirrer and pumped by means of a peristaltic pump through the PPL-80 sensor of the ESA-8000 instrument from Matec. The potentiometric titration with 5M NaOH to pH 10.5 starts from the starting pH. The back-titration to pH 7.5 is undertaken with 5M HNO₃. The evaluation is effected according to

$$ζ = \frac{ESA \cdot η}{φ \cdot Δ ρ \cdot c \cdot \vert G ( α ) \vert \cdot ɛ \cdot {ɛ}_{r}}$$

where
ESA=electrokinetic sound amplitude,
ξ=zeta potential,
φ=volume fraction,
Δρ=density difference between particles and liquid,
c=speed of sound in the suspension,
η=viscosity of the liquid,
ε=dielectric constant of the suspension,
|G(α)|=correction for inertia.

The zeta potential of the cerium oxide particles present in the inventive dispersion is preferably +20 to +60 mV, more preferably +30 to +40 mV.

The mean particle diameter of the cerium oxide particles in the inventive dispersion is not more than 200 nm. Preference is given to a range of 20 to 90 nm. In polishing processes, the best results with regard to removal and defect rate are obtained within this range. The cerium oxide particles may be present in the form of isolated individual particles or else in the form of aggregated primary particles.

The mean particle diameter, in the case of aggregated primary particles the mean aggregate diameter, is preferably less than 200 nm. Particular preference may be given to a range of 50 to 150 nm. The value can be determined, for example, by means of dynamic light scattering.

The proportion of cerium oxide in the inventive dispersion may vary over a wide range. The content of cerium oxide may preferably be 0.01 to 50% by weight, based on the dispersion. High proportions are desired when the intention is, for example, to minimize transport costs. In the case of use as a polishing agent, the proportion of cerium oxide is preferably 0.01 to 5% by weight and more preferably 0.1 to 1% by weight, based on the dispersion.

The cerium oxide particles used preferably have a BET surface area of 30 to 100 m²/g and more preferably of 40-80 m²/g.

The proportion of sodium is generally not more than 5 ppm and that of chlorine not more than 20 ppm. The elements mentioned are generally tolerable only in small amounts in chemomechanical polishing.

The cerium oxide particles may be present as isolated individual particles or else in the form of aggregated primary particles. The inventive dispersion preferably comprises aggregated cerium oxide particles, or the cerium oxide particles are present predominantly or completely in aggregated form.

It has been found to be advantageous to use cerium oxide particles which have an isoelectric point (IEP) at pH values of 9 to 11. This allows the preparation of stable dispersions in the pH range of 7 to 8.5. The IEP indicates the pH at which the zeta potential is zero. The greater the zeta potential, the more stable the dispersion is. The zeta potential can be determined, for example, by measuring the colloidal vibration current (CV1) of the dispersion or by determining the electrophoretic mobility. In addition, the zeta potential can be determined by means of the electrokinetic sound amplitude (ESA).

Particularly suitable cerium oxide particles have been found to be those which contain carbonate groups on their surface and in layers close to the surface. Especially those as disclosed in DE-A-102005038136. These are cerium oxide particles which
have a BET surface area of 25 to 150 m²/g,
the primary particles have a mean diameter of 5 to 50 nm,
the layer of the primary particles close to the surface has a depth of approx. 5 nm,
in the layer close to the surface, the carbonate concentration, proceeding from the surface at which the carbonate concentration is at its highest, decreases toward the interior,
the carbon content on the surface which stems from the carbonate groups is 5 to 50 area percent and, in the layer close to the surface, is 0 to 30 area percent in a depth of approx. 5 nm
the content of cerium oxide, calculated as CeO₂ and based on the powder, is at least 99.5% by weight and
the content of carbon, comprising organic and inorganic carbon, is from 0.01 to 0.3% by weight, based on the powder.

The carbonate groups can be detected both at the surface and in a depth up to approx. 5 nm of the cerium oxide particles. The carbonate groups are chemically bonded and may, for example, be arranged as in the structures a-c.

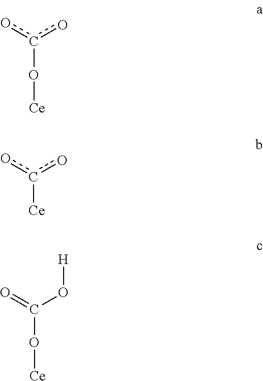

The carbonate groups can be detected, for example, by XPS/ESCA analysis. To detect the carbonate groups in the layer close to the surface, some of the surface can be ablated by means of argon ion bombardment, and the new surface which arises can likewise be analysed by means of XPS/ESCA (XPS=X-ray Photoelectron Spectroscopy; ESCA=Electron Spectroscopy for Chemical Analysis).

The dispersion used in the process according to the invention comprises, in addition to cerium oxide particles, also one or more polymeric, anionic dispersing additives. In this context, “anionic” is understood to mean that the dispersing additive possesses one or more negatively charged functional groups and is formed from a polar moiety and nonpolar moiety. The negatively charged functional group may, for example, be a carboxylate group, a sulphonate group or a sulphate group.

These additives are preferably selected from the group comprising acrylic acid polymers, methacrylic acid polymers, ammonium laurylsulphate and polyoxyethylene lauryl ether ammonium sulphate.

Particular preference is given to polyacrylic acids and/or salts thereof, especially ammonium polyacrylates. The mean (number-average) molecular weight may preferably be 500 to 50 000, particular preference being given to a range of 1000 to 30 000.

The proportion of the polymeric, anionic dispersing additives is preferably 0.1 to 20% by weight, based on cerium oxide.

The dispersion used in the process according to the invention comprises, as well as cerium oxide particles and polymeric, anionic dispersing additive, one or more oxidizing agents, generally with a content of 0.1-20% by weight, based on the dispersion. For this purpose, it is possible to use hydrogen peroxide, a hydrogen peroxide adduct, for example the urea adduct, an organic peracid, an inorganic peracid, an imino peracid, a persulphate, perborate, percarbonate, oxidizing metal salts and/or mixtures of the above. More preferably, hydrogen peroxide can be used. Owing to the reduced stability of some oxidizing agents with respect to other constituents of the inventive dispersion, it may be advisable not to add them until immediately before the use of the dispersion.

The liquid phase of the inventive dispersion comprises water, organic solvents and mixtures of water with organic solvents. In general, the main constituent with a proportion of >90% by weight of liquid phase is water.

The inventive dispersion may further comprise oxidation activators. Suitable oxidation activators may be the metal salts of Ag, Co, Cr, Cu, Fe, Mo, Mn, Ni, Os, Pd, Ru, Sn, Ti, V and mixtures thereof. Additionally suitable are carboxylic acids, nitriles, ureas, amides and esters. Particular preference may be given to iron(II) nitrate. The concentration of the oxidation catalyst may, depending on the oxidizing agent and the polishing task, be varied within a range between 0.001 and 2% by weight. Particular preference may be given to the range between 0.01 and 0.05% by weight.

The corrosion inhibitors, which are generally present in the inventive dispersion with a proportion of 0.001 to 2% by weight, may be nitrogen-containing heterocycles such as benzotriazole, substituted benzimidazoles, substituted pyrazines, substituted pyrazoles and mixtures thereof.

In addition, the dispersion used may also comprise acids, bases, salts. The pH can be adjusted by means of acids or bases. The acids used may be inorganic acids, organic acids or mixtures. The inorganic acids used may especially be phosphoric acid, phosphorous acid, nitric acid, sulphuric acid, mixtures thereof, and the acidic salts thereof. The organic acids used are preferably carboxylic acids of the general formula CₙH₂ₙ₊₁CO₂H where n=0-6 or n=8, 10, 12, 14, 16, or dicarboxylic acids of the general formula HO₂C(CH₂)ₙCO₂H where n=0-4, or hydroxycarboxylic acids of the general formula R₁R₂C(OH)CO₂H where R₁═H, R₂═CH₂, CH₂CO₂H, CH(OH)CO₂H, or phthalic acid or salicylic acid, or acidic salts of the aforementioned acids or mixtures of the aforementioned acids and salts thereof. The pH can be increased by adding ammonia, alkali metal hydroxides, amines or urotropin.

The invention further provides an aqueous dispersion comprising cerium oxide and one or more polymeric, anionic dispersing additives, characterized in that the cerium oxide particles
are present in the form of aggregated primary particles,
have an isoelectric point at pH values of 9 to 11 and
whose mean particle diameter is 20 to 90 nm,
   the proportion of cerium oxide is 0.01 to 10% by weight, based on the dispersion, and the proportion of polymeric, anionic dispersing additive is 0.1 to 20% by weight, based on cerium oxide,
   and the dispersion has a pH of from 7.5 to 10.5.

As polymeric, anionic dispersing additive, the inventive dispersion may preferably comprise polyacrylic acids and/or ammonium salts thereof. The mean number-average molecular weight may be between 500 and 50 000, preferably between 1000 and 30 000.

The dispersion may further comprise an oxidizing agent.

### EXAMPLES

### Analysis

The specific surface area is determined to DIN 66131.

The surface properties are determined by large-area (1 cm²) XPS/ESCA analysis (XPS=X-ray photoelectron spectroscopy; ESCA=electron spectroscopy for chemical analysis). The evaluation is based on the general recommendations according to DIN technical report No. 39, DMA(A)₉₇ of the National Physics Laboratory, Teddington, U.K, and the knowledge to date regarding the development-accompanying standardization of the “Oberflächen- and Mikrobereichsanalysen” [Surface and Microscopic Region Analyses] working committee NMP816(DIN). In addition, the comparative spectra available in each case from the technical literature are considered. The values are calculated by background subtraction, taking account of the relative sensitivity factors of the electron level specified in each case. Data are in area percent. The accuracy is estimated at a relative +/−5%.

The mean aggregate diameters are determined with an LB-500 particle size analyser from Horiba.

The surface roughness of the polished samples was determined by means of:
a. a Censor ANS 100 laser surface scanner, by which the wafers were evaluated for scattered light (haze). The laser spot diameter is about 50 μm; the entire wafer was scanned. Information regarding medium- to long-wave unevenness in the range of a few tens of μm is thus supplied. The measurement unit ppm describes the proportion of scattered light in all of the laser light reflected and cannot be assigned directly to any roughness number.
b. a Digital Instruments “Bioscope” Atomic Force Microscope (AFM) in tapping mode, by which the raw data or the processed (smoothed) data for Rₐ were evaluated. The measurement peak has a radius of curvature in the nm range; the scanned field was 5×2.5 μm in size. The very short-wave roughnesses with nm dimensions are detected.
c. a Micromap 512 white light interferometer from ATOS, by which evaluation both for Rₐ and for peak-valley pv was carried out over the entire measurement field. The size of the measurement field is about 500×500 μm; the spatial resolution is 1 μm. The unevenness detected is thus in the medium-wave range (a few μm).

The removal rates were determined gravimetrically.

### Feedstocks

Cerium oxide: pyrogenic cerium oxide as described in DE-A-102005038136, Example 2.

Analytical data: BET 60 m²/g, particle diameter 65 nm. CeO₂ content 99.79% by weight, C content 0.14% by weight, zeta potential 48 mV at pH=5, IEP at pH=9.8.

### Dispersions

D0: The dispersion is obtained by adding cerium oxide powder to water and dispersing it by ultrasound treatment with an ultrasound finger (from Bandelin UW2200/DH13G), level 8, 100%; 5 minutes), and then adjusting the pH to 7.5 with aqueous ammonia. A dispersion comprising 0.5% by weight of cerium oxide is obtained.
D1: The dispersion is obtained by adding cerium oxide powder and polyacrylic acid [mean number-average molecular weight 2000] to water and dispersing them by ultrasound treatment with an ultrasound finger (from Bandelin UW2200/DH13G), level 8, 100%; 5 minutes), and then adjusting the pH to 7.5 with aqueous ammonia. A dispersion comprising 0.5% by weight of cerium oxide and 0.015% by weight of ammonium polyacrylate is obtained.
D1/H₂O₂: a sufficient amount of aqueous 30 percent by weight hydrogen peroxide solution is added to D1 that the content of hydrogen peroxide is 0.5% by weight. The cerium oxide particle size is 78 nm.
D2: Glanzox® 3900 RS, Fujimi; ammonia-stabilized dispersion of colloidal silicon dioxide, SiO₂ content 10% by weight, pH 10, diluted with water to 0.5% by weight of SiO₂.
D2/H₂O₂: A sufficient amount of aqueous 30 percent hydrogen peroxide solution is added to D2 that the content of hydrogen peroxide is 0.5% by weight. The silicon dioxide particle size is 32-38 nm.

### Wafers:

Untreated: smooth 150 mm monitor wafer.

The polished wafers were cleaned by the integrated brush cleaning system with PVA sponge brushes (PVA=polyvinyl alcohol) in water.

All polishing tests were carried out on a Peter Wolters PM 200 CMP Clustertool. The haze-free polishing step was effected on the touch-up plate of the system using an SPM 3100 pad from Rohm & Haas (industry standard). The process data were

| | | |
|---|---|---|
| downforce | 400 | N |
| chuck speed | 49 | rpm |
| touch-up plate speed | 50 | rpm |
| slurry flow | 400 | ml/min |
| polishing time | 1 | min |

TABLE 1
Polishing results

| | | | | | | | According |
|---|---|---|---|---|---|---|---|
| | | | Comparative examples | | | | to invention |
| | | | 1 | 2 | 3 | 4 | 5 |
| Haze-free | | | D0 | D2 | D1 | D2/H₂O₂ | D1/H₂O₂ |
| polishing | | | | | | | |
| with | | | | | | | |
| Removal | | nm/ | — | 20 | 14.2 | 19.5 | 31.5 |
| rate^{a)} | | min | | | | | |
| Haze | | ppm | 0.065 | 0.059 | 0.164 | 0.128 | 0.089 |
| Rₐ AFM | b) | Å | 1.19 | 1.23 | 1.14 | 1.17 | 0.99 |
| | c) | Å | 1.19 | 1.23 | 1.13 | 1.16 | 0.99 |
| Inter- | Rₐ | Å | 3.6 | 5.5 | 6.4 | 5.1 | 4.2 |
| ferometer | p-v | Å | 44 | 47 | 68 | 47 | 47 |

^{a)}(±2 nm/min);
b) uncleaned;
c) cleaned

Table 1 shows the results of the polishing tests. It is found that a significantly higher removal rate is achieved for D1/H₂O₂. The addition of hydrogen peroxide brings about a doubling of the removal rate compared to D1, in which no hydrogen peroxide is used.

It is additionally found that the haze value for D1/H₂O₂ is somewhat higher than for D1. However, it is only slightly (0.089) above the value for the wafer used (0.065).

The analysis with the AFM, in contrast, gives better roughness values for D1/H₂O₂ in comparison to the starting materials, while D2 and D2/H₂O₂ give rise to values comparable to the starting wafer.

The evaluation for p-v, which also takes account of significant vertical unevenness, gives values corresponding to the starting wafer for D1/H₂O₂.

For D1/H₂O₂ the surfaces of the haze-free polished silicon wafers are hydrophilic after polishing.

1. A process for polishing silicon surfaces, wherein polishing is achieved using a dispersion which comprises cerium oxide particles, at least one polymeric, anionic dispersing additive and at least one oxidizing agent and which has a pH of 7 to 10.5,
said cerium oxide particles having a positive charge and
said polymeric, anionic dispersing additive and said oxidizing agent being soluble in the liquid phase of the dispersion.

2. The process according to claim 1, wherein the cerium oxide particles have a zeta potential of +20 to +60 mV.

3. The process according to claim 1, wherein polishing is achieved using a dispersion in which the mean particle diameter of the cerium oxide particles is not more than 200 nm.

4. The process according to claim 1, wherein polishing is achieved using a dispersion with a proportion of cerium oxide of 0.01 to 50% by weight, based on the dispersion.

5. The process according to claim 1, wherein the cerium oxide particles have a BET surface area of 30 to 100 m²/g.

6. The process according to claim 1, wherein the cerium oxide particles have a proportion of sodium of not more than 5 ppm and of chlorine of not more than 20 ppm.

7. The process according to claim 1, wherein the cerium oxide particles are present in the form of aggregated primary particles.

8. The process according to claim 1, wherein the cerium oxide particles have an isoelectric point at pH values of 9 to 11.

9. The process according to claim 1, wherein polishing is achieved using a dispersion which comprises, as the polymeric, anionic dispersing additive, one or more members selected from the group consisting of acrylic acid polymers, methacrylic acid polymers, ammonium laurylsulphate and polyoxyethylene lauryl ether ammonium sulphate.

10. The process according to claim 1, wherein polishing is achieved using a dispersion which comprises, as the polymeric, anionic dispersing additive, one or more polyacrylic acids and/or salts thereof.

11. The process according to claim 1, wherein the proportion of polymeric, anionic dispersing additive is 0.1 to 20% by weight, based on cerium oxide.

12. The process according to claim 1, wherein polishing is achieved using a dispersion which comprises hydrogen peroxide as the oxidizing agent.

13. The process according to claim 1, wherein the proportion of the oxidizing agent in the dispersion is 0.1 to 20% by weight.

14. The process according to claim 1, wherein polishing is achieved using a dispersion which, apart from cerium oxide particles, comprises no further abrasives.

15. The process according to claim 1, wherein polishing is achieved using a dispersion whose main constituent of the liquid phase is water.

16. The process according to claim 1, wherein polishing is achieved using a dispersion which comprises acids, bases, salts, oxidation catalysts and/or corrosion inhibitors.

17. An aqueous dispersion comprising cerium oxide and a polymeric dispersing additive, wherein the cerium oxide particles
are present in the form of aggregated primary particles,
have an isoelectric point at pH values of 9 to 11 and
have a mean particle diameter of 20 to 90 nm, the proportion of cerium oxide is 0.01 to 10% by weight, based on the dispersion, and the proportion of polymeric, anionic dispersing additive is 0.1 to 20% by weight, based on cerium oxide, and the dispersion has a pH of from 7.5 to 10.5.

18. The aqueous dispersion according to claim 17, wherein it comprises at least one oxidizing agent.
